(19) United States
(12) Patent Application Publication
(10) Pub. No.: US 2009/0002368 A1
(43) Pub. Date: Jan. 1, 2009

(54) METHOD, APPARATUS AND A COMPUTER PROGRAM PRODUCT FOR UTILIZING A GRAPHICAL PROCESSING UNIT TO PROVIDE DEPTH INFORMATION FOR AUTOSTEREOSCOPIC DISPLAY

(75) Inventors: Timo Vitikainen, Espoo (FI); Marko Suoknuuti, Espoo (FI); Jussi Ruutu, Espoo (FI); Ossi Korhonen, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/768,487

(22) Filed: Jun. 26, 2007

(51) Int. Cl. G06T 15/40

(52) U.S. Cl. 345/422; 345/419

(57) ABSTRACT

A device for generating a 3D image based on 2D graphical content of an image and depth information (i.e., Z-map) to be displayed on a display includes an application processor, a graphical processing unit (GPU), a 3D rendering unit and a display. The application processor is capable of sending 2D graphical content to the GPU, which is stored in memory. The GPU also includes a depth table having predefined depth information corresponding to the 2D graphical content. The GPU includes a depth module which monitors or identifies the 2D graphical content and requests a graphics library to paint a corresponding area in the Z-map that has the same size and position in the Z-map as that of the 2D graphical content. The GPU sends the 2D graphical content and the painted Z-map to a 3D rendering unit which creates a 3D image to be shown on a display.

### TECHNOLOGICAL FIELD

Embodiments of the present invention relate generally to mobile electronic device technology and, more particularly relate to methods, apparatuses, and a computer program product for processing of graphics content to facilitate display of three-dimensional content on autostereoscopic displays.

### BACKGROUND

The modern communications era has brought about a tremendous expansion of wireline and wireless networks. Computer networks, television networks, and telephony networks are experiencing an unprecedented technological expansion fueled by consumer demand. Wireless and mobile networking technologies have addressed related consumer demands while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, video recorders, cameras, etc, or even from a combination of the mobile terminal and the network device. In this regard, various applications and software have been developed and continue to be developed in order to give the users robust capabilities to perform tasks, communicate, entertain themselves, gather and/or analyze information, etc. in either fixed or mobile environments.

An example of an application that may be used to enhance a user's experience consists of autostereoscopic displays which display three-dimensional (3D) graphical content. For instance, mobile devices have evolved into multi-purpose devices (e.g., personal computers, gaming devices). The style and presentation of the graphical content displayed on mobile devices is becoming increasingly important and is often a major differentiating aspect among the wide array of mobile devices available in the market. Images shown on autostereoscopic displays contain visually perceived depth to create the 3D experience. The person viewing the display sees objects that appear to go inside the plane of a display or come out of that plane (in a similar way to holograms). This is typically achieved by producing slightly different images for the left eye and the right eye. (See FIG. 1) As known to those skilled in the art, rendering of three-dimensional content follows a highly parallel and deeply pipelined model. Since graphics rendering is a highly computationally intensive task, in modern computing devices an enormous amount of computations are often performed in a special hardware unit called a Graphics Processing Unit (GPU).

Due to the large amount of computations, an important benefit of the GPU is that it minimizes the burden of a processor such as an application processor from performing all of the computations necessary for 3D rendering. In this regard, the GPU may free up the application processor to perform other tasks and may lighten the application processor's load. As known to those skilled in the art, to create a 3D image, a display requires a two-dimensional (2D) representation of an image and a depth-map (i.e., a Z-map). The depth map may specify a distance between each pixel and a viewer (i.e., person). The 2D image and the depth-map (Z-map) are used to generate images on a display and these images are combined in the viewer's brain to create a 3D graphical effect. Currently, application processors typically process the depth information (Z-map) associated with a 2D graphical image. For instance, an application processor typically receives content associated with an image or video clip (e.g. game content) and calculates the depth information (Z-map) as numeric data and is then processed by the application processor in a format suitable for 3D rendering. Calculating the depth information into numeric data and processing this data consumes resources and may slow down the 3D rendering process.

In this regard, it would be beneficial for the GPU to process the depth information associated with the 2D graphical content such that rendering to the display would be faster, efficient and free the application processor to perform other duties, which serves to lessen the load of the application processor as well as lessen power consumption of an electronic device such as, for example, a mobile device.

### BRIEF SUMMARY

The exemplary embodiments of the present invention provide a method, computer program product and device for processing of graphics content in electronic devices such as mobile terminals (e.g., mobile phone) in real-time to be suitable for 3D rendering to multi-view autostereoscopic 3D displays. In the exemplary embodiments of the present invention, depth information of the original 2D graphics image is processed and presented as a 2D graphics image. As such, depth information (i.e., Z-map) associated with the 2D graphics image is created using the graphics functions of the GPU and thus the application processor is not needed for processing the depth information. In this regard, the processing load of the application processor is decreased freeing the application processor to perform or execute other functions.

In one exemplary embodiment, a method and a computer program product and a means for generating a 3D image are provided. The method and computer program product includes identifying at least a first 2D graphical image from among one or more 2D graphical images for which depth information is predefined. The method and computer program product further includes retrieving the predefined depth information corresponding to the first 2D graphical image, using the retrieved predefined depth information, a size and a position corresponding to the first 2D graphical image to generate a request and painting an area based on the depth information and corresponding to the size and the position of the first 2D graphical image based on the request.

In another exemplary embodiment a device for generating a 3D image is provided. The device includes a hardware unit having a processing element and a memory wherein the memory is configured to store predefined depth information associated with one or more two-dimensional (2D) graphical images. The device further includes a depth module in communication with the hardware unit and configured to identify at least a first 2D graphical image from among one or more 2D graphical images to retrieve the predefined depth information corresponding to the first 2D graphical image and to use the retrieved predefined depth information, a size and a position corresponding to the first 2D graphical image to generate a request which is sent to a library module. The device further includes the library module which is in communication with the depth module and configured to paint an area based on the predefined depth information corresponding to the size and the position of the first 2D graphical image based on the received request.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram of an autostereoscopic display;

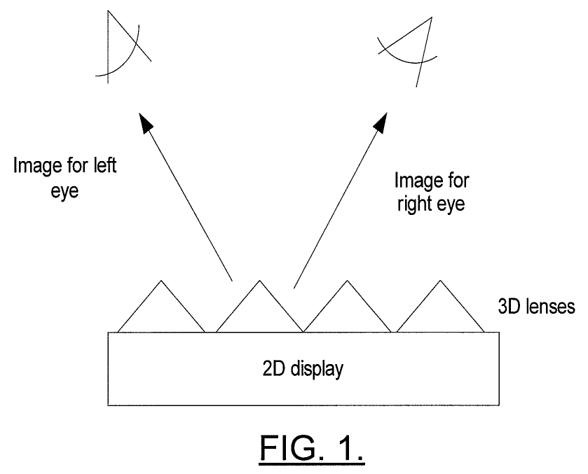

FIG. 2 is a schematic block diagram of a mobile terminal according to an exemplary embodiment of the present invention.

FIG. 3 is a schematic block diagram of a wireless communications system according to an exemplary embodiment of the present invention;

FIG. 4 is a schematic block diagram of a graphics processing unit (GPU) according to an exemplary embodiment of the present invention;

FIGS. 5A and 5B are diagrams of 3D content viewed as a combined image of RGB and depth information; and

FIG. 6 is a flowchart of a method for utilizing 2D graphical content and depth information to generate a 3D image.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

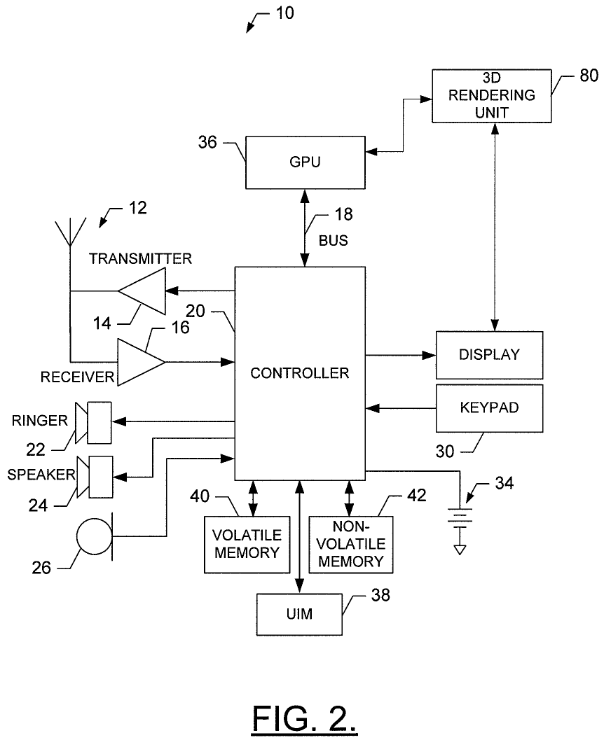

Referring now to FIG. 2, an illustration of a block diagram of a mobile terminal 10 that would benefit from embodiments of the present invention is provided. It should be understood, however, that a mobile telephone as illustrated and hereinafter described is merely illustrative of one type of mobile terminal that would benefit from embodiments of the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries. In exemplary embodiments, the system and method of the present invention are applicable to autostereoscopic displays. However, it should be noted that the system and method of the present invention are also applicable to other stereoscopic displays which have one or more common elements in the display process to autostereoscopic displays. As used herein, the terms “stereoscopic” and “autosteroscopic” are used interchangeably. As such, stereoscopic displays encompasses autostereoscopic displays and other similar stereoscopic displays.

The mobile terminal 10 includes an antenna 12 in operable communication with a transmitter 14 and a receiver 16. The mobile terminal 10 further includes a controller 20 or other processing element (such as, for example, a CPU) that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 may include a graphics processing unit (GPU) 36 in communication with the controller 20, (controller 20 is also referred to herein as an application processor) or other processing element such as a central processing unit (CPU), for example. (As referred to herein, a GPU encompasses graphics hardware on a computer and/or on a mobile device.) The GPU 36 may be any means, in hardware or software, capable of processing raw 2D content and depth information (i.e., a Z-map) for generating 3D content or a 3D graphical image. For instance, the GPU 36 is capable of processing a number of primitives corresponding to video data (e.g., video clip, movie, video game and the like) of a scene or image data to produce all of the 2D or 3D data points corresponding to the scene or image so that the scene or image can be viewed on a display (e.g., display 28). In an exemplary embodiment, display 28 may be a stereoscopic display, such as for example, a lenticular display. Additionally, GPU 36 is capable of sending 2D graphical content and depth information (Z-map) to the 3D rendering unit 80 and the 3D rendering unit generates a corresponding 3D image which is shown on display 28. The controller 20 may include functionality to execute one or more 3D applications which may be stored in memory. The 3D applications executed by the controller 20, include but are not limited to, applications such as 3D video conferencing, 3D user interface, games as well as 3D applications associated with maps, calendars, address books, advertisements, image viewers, message viewers, file browsers, web browsers, e-mail browsers and the like. The controller is capable of sending graphical content, such as for example, 2D graphical image data (e.g. images, video data such as movies, video games, graphical animations and the like) to the GPU, via bandwidth bus 18. Additionally, the controller 20 is capable of sending 2D graphical user interface (UI) components to the GPU, via bandwidth bus 18. As referred to herein, a graphical user interface includes but is not limited to a type of user interface which allows people to interact with a computer and computer-controlled devices which employ graphical icons, visual indicators or special graphical elements along with text labels or text navigation to represent the information and actions available to a user, and the like, on a display. Examples of graphical UIs include but are not limited to MICROSOFT WINDOWS, and mobile UIs such as for e.g., Series 60 UI or Hildon UI. In this regard, a graphical user interface has an influential aspect on application programming. The visible graphical interface features of an application include graphical elements or UI graphical components that may be used to interact with the program, such as for example windows, notification boxes, title bars, buttons, menus, scroll bars and the like (also referred to herein as graphical UI component classes). The controller 20 is capable of sending data associated with these UI graphical components to the GPU, via bandwidth bus 18, when a user selects the graphical element to be drawn or shown on the display 28. Additionally, the controller 20 is capable of sending vertices to GPU 36 (via bandwidth bus 18). The received vertices correspond to primitives that are associated with an area of an image or scene of a 3D application that requires rendering (i.e., producing the pixels of an image or scene based on primitives).

The 3D rendering unit 80 is any device or means in hardware and/or software capable of receiving 2D graphical content and the information related to a painted area in a Z-Map, generated by the GPU 36, and is capable of creating the actual 3D image (or animation for a scene) which is shown on display 28. The actual 3D image is created based on the 2D graphical content and the depth-map information (i.e., Z-map). The 3D rendering unit 80 may be a part of and located internal to the GPU 36. In an alternative exemplary embodiment, the 3D rendering unit 80 may be a processor, co-processor, controller and the like.

In exemplary embodiments of the present invention, bandwidth bus 18 may be a Peripheral Component Interconnect (PCI) bus, an Advanced Graphics Processor (AGP) bus or the like. As used herein, the terms “content,” “image data,” “video data,” “information” and similar terms may be used interchangeably to refer to data capable of being transmitted, received and/or stored in accordance with embodiments of the present invention. Thus, the use of such terms should not be taken to limit the spirit and scope of the present invention.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

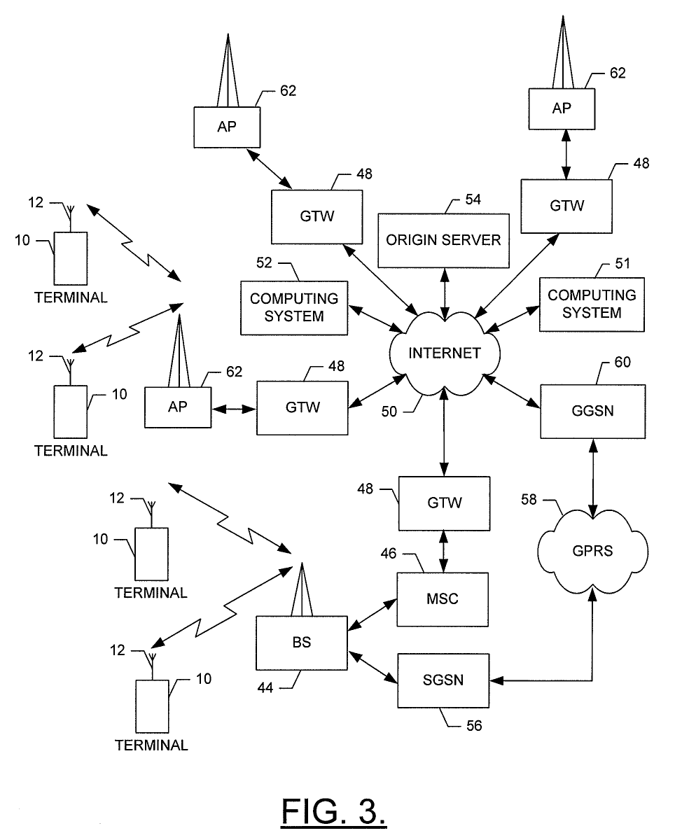

Referring now to FIG. 3, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 3, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 3), origin server 54 (one shown in FIG. 3) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 3, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

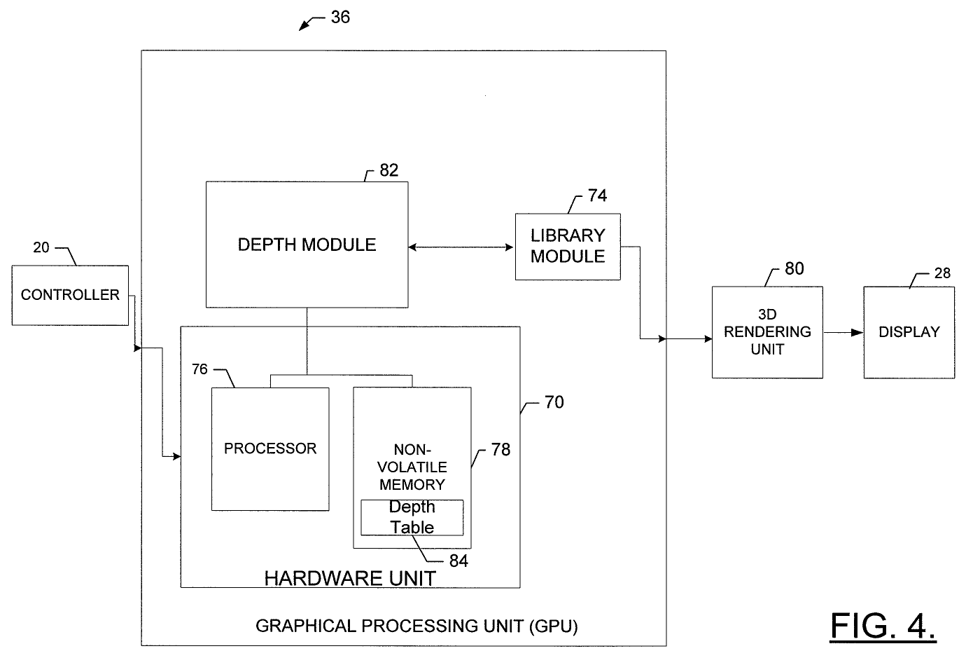

An exemplary embodiment of the invention will now be described with reference to FIG. 4, in which certain elements of GPU 36 are displayed. The GPU 36 may be employed, for example, on the mobile terminal 10 of FIG. 2. However, it should be noted that the GPU 36 of FIG. 4, may also be employed on a variety of other devices, both mobile and fixed, and therefore, embodiments of the present invention should not be limited to application on devices such as the mobile terminal 10 of FIG. 2. For example, the GPU of FIG. 4 may be employed on a personal or desktop computer, etc. It should also be noted that while FIG. 4 illustrates one example of a configuration of the GPU, numerous other configurations may also be used to implement other embodiments of the present invention. For instance the functions and elements of the GPU 36 may be implemented by the controller, i.e., application processor 20.

Referring now to FIG. 4, an exemplary embodiment of a GPU for stereoscopic rendering having the capability of generating 2D graphical content and depth information i.e., depth-map (e.g., Z map) is provided. The GPU 36 includes a hardware unit 70 having a processor 76 and a non-volatile memory 78 which includes a depth table 84, a depth module 82, and a graphics library such as library module 74. The processor 76 is capable of executing software (which may be stored in non-volatile memory 78) and/or performing functions of the GPU 36. The non-volatile memory 78 includes but is not limited to a flash memory, read-only memory, or the like capable of storing the depth table 84. The depth table 84 may be any means or device in hardware and/or software capable of storing predefined depth information (i.e., Z-map) corresponding to graphical user interface components such as notification boxes, title bars, windows, scroll bars, buttons, menus and the like corresponding to an application program(s). The non-volatile memory 78 is also capable of storing the RGB data associated with corresponding x, y coordinates of the pixels and according to the exemplary embodiments of the present invention, the depth table 84 is capable of storing a Z-map having z-plane values associated with corresponding pixels of graphical content such as for example, graphical UI components, 2D graphical content and the like. The z-plane values may correspond to one or more gray scale color numbers.

Additionally, the depth information stored in the depth table includes but is not limited to gray scale color numbers. In this regard, the gray scale color numbers are color coding numbers which may serve as values corresponding to the depth of one or more pixels and are capable of impacting the color of the Z-plane value for a respective pixel such that the more distant the object is on display 28, the darker its pixel and the closer the object is on display 28, the lighter its pixel. The depth module 82 may include any means of hardware and/or software (executed by processor 76 or application processor 20) capable of identifying or monitoring 2D graphical data input to the hardware unit 70. In this regard, the depth module may include any software embodied in computer readable code.

The library module 74 includes any device or means in hardware and/or software (executed by, e.g., processor 76) capable of painting an area in the Z-map of the depth table 84 and executing function calls and the like, in a graphics framework such as for example, Open Graphics Library (OpenGL), OpenGL ES, (i.e., OpenGL for Embedded Systems, which is a subset of the OpenGL 3D graphics application program interface implemented for embedded devices such as mobile electronic devices such as for example, mobile phones, personal digital assistants (PDAs) and the like) Direct3D, Mesa 3D and the like, for rendering 3D graphics content. In this regard, the library module 74 may define a cross-language cross-platform application programming interface (API) for writing applications that produce 3D computer graphics. The function calls may be used to draw three-dimensional scenes from simple primitives such as geometric primitives (e.g., points, lines, polygons and for example primitives corresponding to graphical UI components) and convert them into pixels which are outputted to 3D rendering unit 80. The 3D rendering unit 80 is any device or means in hardware and/or software capable of receiving 2D graphical content and the information related to the painted area in the Z-Map, generated by the library module 74, and is capable of creating the actual 3D image (or animation for a scene) which is shown on display 28. The actual 3D image is created based on the 2D graphical content and the depth-map information (i.e., Z-map).

When graphical UI components are drawn to the display 28, such as for example, a notification box, in a software application, 2D graphical content associated with the UI component is input to the application processor 20 which provides this information to the hardware unit 70 of the GPU 36. (This 2D graphical content associated with the drawn UI component may, but is not necessarily, in the form of geometric primitives, for example triangles used to represent an area of an image. In an alternative exemplary embodiment, a user of the mobile terminal may select a graphical UI component to be drawn to the display and 2D graphical content associated with the selected UI component is input to the application processor 20 which provides this information to the hardware unit 70 of the GPU 36.) The processor 70 analyzes the 2D graphical data associated with the graphical UI component and stores this 2D graphical data in memory 78. For example, the processor 70 is capable of classifying the 2D graphical content or data associated with the graphical UI, determining a size of the 2D graphical data and identifying the coordinates of the 2D graphical data which is provided to the memory 78 for storage. More particularly, the 2D graphical data associated with graphical UI components described herein may have a type/class attribute(s) (e.g., component class) and in this regard, the processor 70 is capable of utilizing the type/class attribute(s) of each graphical UI component to classify a corresponding graphical UI component. For instance, the processor 70 may classify the 2D graphical data as a graphical UI component having a class/type attribute, such as a component class corresponding to a notification box, title bar, scroll bar, window, menu button and the like. (It should be pointed out that all graphical UI components (e.g., all graphical UI component types/classes) of the exemplary embodiments of the invention have predefined depth values, such as for example, gray scale color coding numbers, that are stored in the depth table 84.)

The depth module 82 monitors or identifies the 2D graphical data associated with the UI component(s) which is stored in memory 78 and is capable of detecting that a particular (in this e.g., the notification box) graphical UI component needs to be drawn or shown on the display 28. By identifying the 2D graphical data associated with the UI component(s), the depth module 82 may constantly monitor graphical UI component library calls (e.g., library calls for drawing graphical UI components such as for example, notification boxes, title bars, buttons, menus and the like) which are stored in the library module 74. The depth module 82 is capable of receiving data, from a respective graphical UI component library call (e.g., library call for a notification box) which includes but is not limited to the type/class, size, position and coordinates of the graphical UI component, which is stored in the memory 78 by the processor 76. The depth module 82 then retrieves or fetches depth information (i.e., Z map data) for the graphical UI component from the depth table 84. In this regard, the depth module 82 retrieves or fetches the predefined gray scale color number(s) associated with the graphical UI component (e.g., notification box) in the Z-map. (In an alternative exemplary embodiment, the depth module 82 may retrieve or fetch the predefined gray scale color number(s) associated with the graphical UI component in the Z-map based on the type/class attribute (e.g. component class, which includes but is not limited to notification boxes, title bars, menus, windows and the like) of the graphical UI component. That is to say, once the depth module 82, determines the type/class of the 2D graphical data stored in memory 78, the depth module is able to retrieve or fetch the respective predefined gray scale color number(s) stored in the depth table 84)

The depth module 82 uses the retrieved depth information (i.e., the gray scale color numbers), the class/type attributes, the size and position (i.e., coordinates) information associated with the graphical UI component and sends a request to the library module 74 to paint an area corresponding to the Z-map that has the same size and the same position in the Z-map as that of the graphical UI component to be the drawn or shown on display 28. As such, the library module 74 paints the corresponding area in the Z-map. That is to say, the library module 74 paints the area corresponding to the gray scale color number(s) predefined in the depth table 84 for the particular graphical UI component (e.g. notification box) using a library call(s) stored in the library module 74. By painting the area corresponding to the gray scale color numbers, color is added to the respective portion(s) of the Z-map. This painted area in the Z-map, generated by the library module 74, is sent, along with corresponding 2D graphical data (e.g., 2D graphical data associated with a graphical UI component) to the 3D rendering unit 80, which creates the actual 3D image of the graphical UI component (e.g. the notification box) which is outputted to display 28. In this regard, the graphical UI component is drawn or shown on the autostereoscopic display 28 with the depth information, for example, the grayscale color number(s) pre-defined for the component (e.g., notification bar) in the depth table 84.

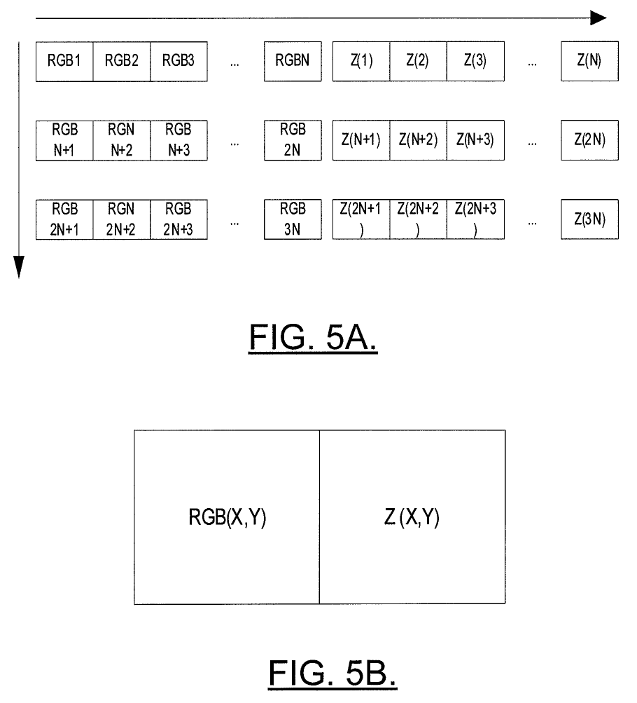

As can be seen in FIGS. 5A and 5B, it should be pointed out that the 2D graphical content associated with the graphical UI component processed by the processor 76 may be in a form having one or more rows with each row having a first portion (of length N) associated with a plurality of pixels with (x, y) coordinates and containing a plurality of Red-Green-Blue color model (RGB) data values for respective pixels 1, 2, . . . N followed by a second portion containing depth information (Z-map information) for the same respective pixels. The processor 76 is capable of outputting the RGB data corresponding to the respective pixels and associated with the 2D graphical UI component(s) to the non-volatile memory 78 for storage. The depth table 84 is capable of storing the depth information (Z-map) in a predefined format corresponding to pre-defined graphical UI components.

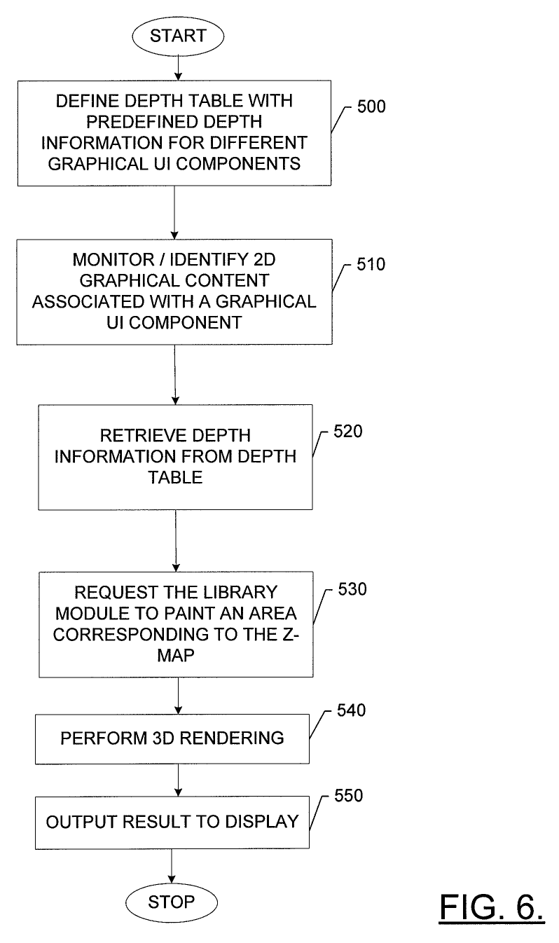

FIG. 6 is a flowchart illustrating a method for utilizing 2D graphical content and depth information to generate a 3D image. The method includes defining and assigning a depth table with predetermined depth information, such as for example gray scale color numbers, which corresponds to one or more graphical user interface components, at operation 500. At operation 510, the depth module 82 monitors or identifies 2D graphical content, associated with a graphical UI component, which is input to the hardware 70, by the GPU 36, and analyzed by processor 76 and the depth module receives data corresponding to the graphical UI component which includes but is not limited to class, size and coordinates associated with the graphical UI component to be drawn or shown on display 28. The depth module 82 may monitor or identify the 2D graphical content when a user of mobile terminal 10 selects a graphical UI component (e.g., title bar) of an application program to be drawn or shown on display 28. At operation 520, the depth module 82 retrieves depth information, such as for example gray scale color numbers associated with the graphical UI component to be drawn or shown on display 28 (in this e.g., the title bar). At operation 530, the depth module 82, uses the received depth information, for example a gray scale color number(s) representing a value of the depth of a pixel(s), the size and position information (e.g., coordinates) of the graphical UI component (e.g., title bar) to be drawn or shown on display 28 and requests the library module 74 to paint an area in the Z-map that has the same size and the same position in the Z-map that corresponds to the graphical UI component to be drawn or shown on display 28. The library module 74 may paint the area in the Z-map using any suitable painting and graphics effect features of a 3D graphics API library (e.g. OpenGL, OpenGL ES and the like). For example, the library module 74 may paint the area in the Z-map using the fog feature of OpenGL ES. At operation 540, the painted area in the Z-map and the 2D graphical content (e.g., raw 2D graphical image data) associated with the graphical UI component (e.g., title bar) is outputted to the 3D rendering unit 80, which utilizes the 2D graphical content and the depth information to generate a 3D image which is outputted to display 28. At operation 550, the display 28 shows the graphical UI component in a 3D image. By using the predefined depth values in the depth table to paint the corresponding area in the Z-map, the graphical UI component(s) can be brought closer to viewer (i.e., user of the mobile terminal 10) on display 28.

It should be understood that each block or step of the flowcharts, shown in FIG. 6 and combination of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
identifying at least a first 2D graphical image from among one or more 2D graphical images for which depth information is predefined;
retrieving the predefined depth information corresponding to the first 2D graphical image;
using the retrieved predefined depth information, a size and a position corresponding to the first 2D graphical image to generate a request; and
painting an area based on the depth information and corresponding to the size and the position of the first 2D graphical image based on the request.

2. The method of claim 1, further comprising:
using the painted area based on the depth information and 2D data associated with the first 2D graphical image to generate a 3D image; and
displaying the 3D image.

3. The method of claim 1, wherein the depth information comprises a Z-map having a plurality of z-plane values associated with corresponding pixels of the 2D graphical images.

4. The method of claim 3, wherein the z-plane values comprise one or more gray scale color numbers, each of the color numbers define a depth of one or more corresponding pixels related to the one or more 2D graphical images.

5. The method of claim 1, wherein the one or more 2D graphical images comprise one or more graphical user interface components.

6. The method of claim 1, wherein prior to the identifying, further comprising:
selecting the first 2D graphical image for display;
receiving data associated with the first 2D graphical image; and
classifying the first 2D graphical image and determining the size and the position of the first 2D graphical image,
wherein identifying comprises detecting the received data.

7. The method of claim 6, wherein detecting comprises, detecting a class of the first 2D graphical image, the size and one or more coordinates of the first 2D graphical image.

8. The method of claim 1, wherein the first 2D graphical image comprises at least one of, a window, a notification box, a title bar, a button, a menu and a scroll bar.

9. The method of claim 1, wherein painting comprises using a function call of an Open Graphics Library for Embedded Systems (OpenGL ES) to paint the area in the depth information.

10. The method of claim 2, wherein the one or more 2D graphical images comprise red-green-blue (RGB) data associated with x, y coordinates of corresponding pixels of the 2D graphical images.

11. The method of claim 10, wherein the 3D image comprises RGB data corresponding to the first 2D graphical image and the painted area in the depth information.

12. A computer program product, the computer program product comprising at least one computer-readable storage medium having computer-readable program code portions stored therein, the computer-readable program code portions comprising:
a first executable portion for identifying at least a first 2D graphical image from among one or more 2D graphical images for which depth information is predefined;
a second executable portion for retrieving the predefined depth information corresponding to the first 2D graphical image;
a third executable portion for using the retrieved predefined depth information, a size and a position corresponding to the first 2D graphical image to generate a request; and
a fourth executable portion for painting an area based on the depth information and corresponding to the size and the position of the first 2D graphical image based on the request.

13. The computer program product according to claim 12, further comprising:
a fifth executable portion for using the painted area based on the depth information and 2D data associated with the first 2D graphical image to generate a 3D image; and
a sixth executable portion for displaying the 3D image.

14. The computer program product of claim 12, wherein prior to the execution of the first executable portion, further comprising:
a fifth executable portion for selecting the first 2D graphical image for display;
a sixth executable portion for receiving data associated with the first 2D graphical image; and
a seventh executable portion for classifying the first 2D graphical image and determining the size and the position of the first 2D graphical image,
wherein identifying comprises detecting the received data.

15. The computer program product of claim 12, wherein the depth information comprises a Z-map having a plurality of z-plane values associated with corresponding pixels of the 2D graphical images and wherein the z-plane values comprise one or more gray scale color numbers, each of the color numbers define a depth of one or more corresponding pixels related to the one or more 2D graphical images.

16. A device, comprising:
a hardware unit having a processing element and a memory wherein the memory is configured to store predefined depth information associated with one or more two-dimensional (2D) graphical images;
a depth module in communication with the hardware unit and configured to identify at least a first 2D graphical image from among the one or more 2D graphical images to retrieve the predefined depth information corresponding to the first 2D graphical image and to use the retrieved predefined depth information, a size and a position corresponding to the first 2D graphical image to generate a request which is sent to a library module; and
the library module in communication with the depth module and configured to paint an area based on the predefined depth information corresponding to the size and the position of the first 2D graphical image based on the received request.

17. The device of claim 16, further comprising,
a 3D rendering unit and a display, the 3D rendering unit configured to receive communication from the library module and output a 3D image to the display, and
wherein the 3D rendering unit is configured to receive data associated with the painted area and 2D data associated with the first 2D graphical image, from the library module, and to generate a 3D image which is output to and shown by the display.

18. The device of claim 16, wherein the depth information comprises a Z-map having a plurality of z-plane values associated with corresponding pixels of the 2D graphical images.

19. The device of claim 18, wherein the z-plane values comprise one or more gray scale color numbers, each of the color numbers define a depth of one or more corresponding pixels relate to the one or more 2D graphical images.

20. The device of claim 16, wherein the one or more 2D graphical images comprise one or more graphical user interface components.

21. The device of claim 16, wherein the processing element is further configured to:
select the first 2D graphical image for display;
receive data associated with the first 2D graphical image; and
classify the first 2D graphical image and determine the size and the position of the first 2D graphical image,
wherein the depth module is further configured to detect the received data.

22. The device of claim 16, wherein the first 2D graphical image comprises at least one of a window, a notification box, a title bar, a button, a menu and a scroll bar.

23. The device of claim 17, wherein the one or more 2D graphical images comprise red-green-blue (RGB) data associated with x, y coordinates of corresponding pixels of the 2D graphical images.

24. The device of claim 23, wherein the 3D image comprises RGB data corresponding to the first 2D graphical image and the painted area in the depth information.

25. A device, comprising:
means for identifying at least a first 2D graphical image from among one or more 2D graphical images for which depth information is predefined;
means for retrieving the predefined depth information corresponding to the first 2D graphical image;
means for using the retrieved predefined depth information, a size and a position corresponding to the first 2D graphical image to generate a request; and
means for painting an area based on the depth information and corresponding to the size and the position of the first 2D graphical image based on the request.
